(19) United States
(12) Patent Application Publication
(10) Pub. No.: US 2022/0020085 A1
(43) Pub. Date: Jan. 20, 2022

(54) SYSTEM AND METHOD FOR PROVIDING AUTOMATED PREDICTIVE INFORMATION ON A USER INTERFACE

(71) Applicant: THE TORONTO-DOMINION BANK, TORONTO (CA)

(72) Inventor: Esterina DEGRAZIA, Georgetown (CA)

(21) Appl. No.: 16/929,741

(22) Filed: Jul. 15, 2020

(51) Int. Cl. G06Q 40/02; G06F 16/9535; G06F 16/9536; G06F 16/9538; G06F 16/9537; G06F 16/958

(52) U.S. Cl. CPC G06Q 40/02; G06F 16/9535; G06F 16/9536; G06F 9/451; G06F 16/9537; G06F 16/958; G06F 16/9538

(57) ABSTRACT

A computing device configured to communicate with a display for a user interface of a data management application for presenting predictive resource information on the display. The computing device monitors an account history on an account associated with a user of an institution comprising: data defining operations performed on the account over a period of time and metadata characterizing each product held on the account. The computing device also monitors online actions resulting from interactions with the user interface for the account. Based on the history and the online actions, the computing device predicts a user's interest for subsequent information for the user interface; determines resources related to the user's interest and proactively presents on the user interface, in real-time, the resources along with account information for performing one or more account operations in a consolidated view for subsequent interaction.

### FIELD

The present disclosure generally relates to computer interfaces of a data management application and more particularly, to a system and method for automatically providing predictive digital information including online resources determined to be of interest on the user interface while accessing current data management information on a client device.

### BACKGROUND

Currently, graphical user interfaces for software applications (e.g. which are accessible via a native software application or a web browser) on a client computer device having an account with an institution are limited in the digital content displayed as they only allow a user to review their account data and perform pre-set transactions which are similarly available to all users.

For example, digital data management platforms provide online services on a user interface of a client device allow access to only allow fixed types of account information and a set of digital data transformation services, such as: depositing; performing an electronic data transfer; or displaying specific views of the financial information. That is, the same types of information and/or services are presented on the user interface for all users. Since the information is not customized, the vast majority of the information presented, including the services available, may be completely superfluous to a user and only of interest to a small subset of users.

Current graphical user interfaces are unable to display functions and information that may be most relevant to a particular user at a particular point in time when navigating digital platforms. Thus, a user would currently need to manually digest account information visible on a user account of a digital platform, then manually access and search for a variety of different online information while relying on various external search engines, including untrusted sources, outside the digital data management platform to manually search for, review and analyze user account information such as current financial health status. This approach is resource intensive, tedious, using computer resources unnecessarily and leading the user to untrusted sources of information.

Additionally, such a fixed and non-customized approach for providing digital information to a user (e.g. via a digital platform) is thus limited in content relevance and relies on the user to manually search for additional resources and information relevant to the user thereby wasting resources.

Thus, it is vital to automatically proactively provide digital resources with desired customized content on graphical user interfaces such as to obviate or mitigate at least some or all of the above presented disadvantages. Notably, it is helpful to do so simply and efficiently to avoid wasting computing resources.

### SUMMARY

It is an object of the disclosure to provide an improved method of monitoring data health and online activity and proactively predicting a user's interests to display data health information and resources based on the interests on a data management platform.

The proposed solution is meant to move away from a fixed, static, non-customized user interface to a proactive model in which data management applications are automatically and in real-time personalized to meet a user's current interest as well projected or forecasted interests in additional internal or external resources (e.g. financial tools proactively and dynamically displayed). For example, this includes predicting that the user may have lost their job and thus display online financial resources in a screen along with current information for an account.

In accordance with one aspect of the present disclosure there is provided a content processing device communicating with a computing device across a communication network, the content processing device having a processor coupled to a memory, the memory storing instructions, which when executed by the processor configure the content processing device to: monitor, via the computing device, a history on an account associated with a user of an institution, the history comprises: data defining operations performed on the account over a period of time and metadata characterizing each product held on the account over the period of time; monitor online actions resulting from interactions with a user interface of a data management application on the computing device for the account; predict, based on the history and the online actions, a user's interest for subsequent information for the user interface on the computing device; in response to the prediction: determine, in real-time, one or more resources related to the user's interest; and, proactively present on the user interface, in real-time, the resources along with account information for performing one or more account operations in a consolidated view for subsequent interaction.

The online actions may further comprise one or more queries for additional information made on the user interface relating to the account.

The instructions may further configure the content processing device to receive a first interaction selecting on the user interface one of the resources for further detailed display; and, update the user's interest further based upon the first interaction to determine and present on the user interface the resources based on the updated user's interest.

The instructions may further configure the content processing device to present in a consolidated view on a screen of the user interface a summarized view of icons comprising: the account information defining the history associated with a first selectable icon for further detailed view and manipulation of the account information in a second screen on the user interface; and, the resources associated with a second selectable icon for further detailed view and manipulation in a third screen on the user interface.

The resources presented may be web page links to external websites providing account services related to the user's interest and determined as trusted by the institution.

The resources may be software application tools presented on the user interface for predicting health of the account in view of a corresponding goal for the data and at least based on the history and the online actions.

The resources may be presented as an interactive set of selectable display tiles on a screen of the user interface organized by content category of the resources.

The instructions may further configure the processor to further analyze the history to determine data transfer patterns in the account characterizing behaviour of data transfer operations on the account including product categories involved in the data transfer operations, associated frequency and timeline; and further wherein the resources are additionally updated based upon the data transfer patterns in the history.

The instructions may further configure the processor for displaying the resources as an alert on a screen of the user interface in response to navigating and interacting with the user interface.

The instructions may further configure the content processing device to: receive profile attributes for the user and other users of the institution; determine a set of the other users of the institution having similar demographic data based on the profile attributes; track an online behaviour pattern of the set of the other users of the institution in interacting with respective user interfaces for customization of information provided thereon; and wherein the user's interest in subsequent information is further updated based on the online behaviour pattern of the set of the other users and used for determining and presenting the resources based on the update.

The instructions may further configure the content processing device for: tracking a current geographic location of the computer device when interacting with the data management application, and further determining the user's interest based on the current geographic location to further customize the resources displayed only to those relevant to the current geographic location.

In accordance with another aspect of the present disclosure, there is provided a computer implemented method for providing predictive information on a user interface of a data management application of a computer device, the method comprising: monitoring a history on an account associated with a user of an institution, the history comprises: data defining operations performed on the account over a period of time and metadata characterizing each product held on the account over the period of time; monitoring online actions resulting from interactions with the user interface for the account; predicting, based on the history and the online actions, a user's interest for subsequent information for the user interface; in response to the predicting: determining, in real-time, one or more resources related to the user's interest; and, proactively presenting on the user interface, in real-time, the resources along with account information for performing one or more account operations in a consolidated view for subsequent interaction.

There is provided a computer program product comprising a non-transient storage device storing instructions that when executed by at least one processor of a computing device, configure the computing device to perform in accordance with the methods described herein.

### BRIEF DESCRIPTION OF THE DRAWINGS

These and other features of the disclosure will become more apparent from the following description in which reference is made to the appended drawings wherein:

FIG. 1 is a diagram illustrating an example computer network having a computing device configured to output for display a graphical user interface on a client device providing predictive digital information for a data management application, in accordance with one or more aspects of the present disclosure.

FIG. 2 is a diagram illustrating an example computing device (e.g. content processing device), in accordance with one or more aspects of the present disclosure.

FIGS. 3A and 3B are diagrams illustrating example graphical user interface screens or portions thereof of the client computing device of FIG. 1, in accordance with one or more aspects of the present disclosure.

FIG. 4 is a flowchart illustrating example operations of a computing device (e.g. content processing device 104), in accordance with one or more aspects of the present disclosure.

### DETAILED DESCRIPTION

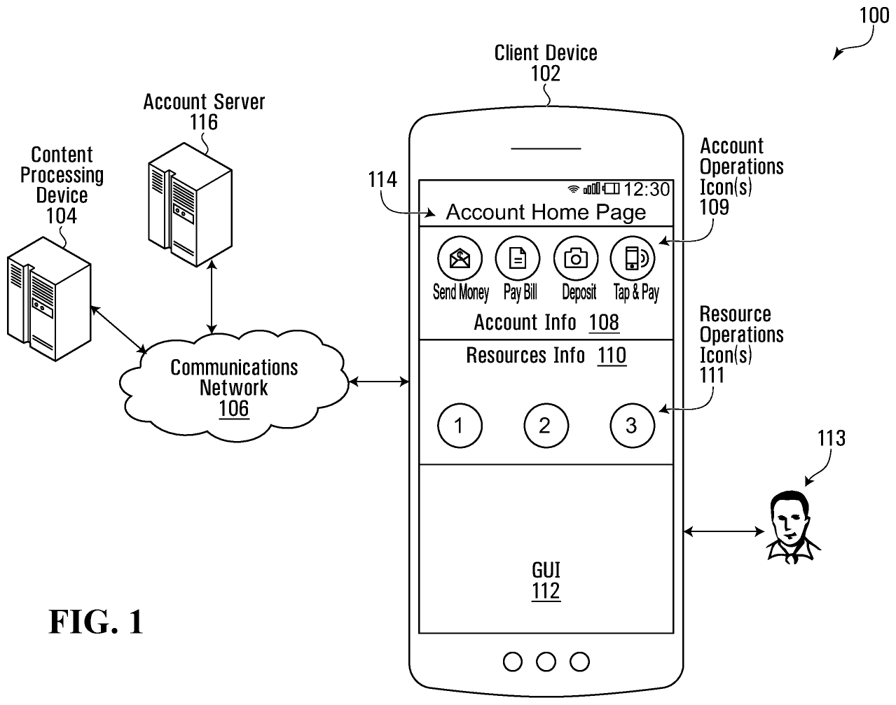

FIG. 1 is a diagram illustrating an example computer network 100 in which a client computing device 102 is configured to communicate with one or more other computing devices, including a content processing device 104, using a communications network 106.

Content processing device 104 is configured to provide digital content corresponding to one or more digital resources (e.g. website links, access to software tools or online digital platform resources) forecasted to be of interest to a user 113 while navigating and/or otherwise interacting with a graphical user interface 112 of a data management application 114 on the client computing device 102. Notably, the content processing device 104 monitors and processes activity for a particular account or database record held with an institution along with online actions resulting from interactions with the client computing device 102 on the graphical user interface (GUI) 112 of the data management application 114. Such account activity may be stored on the client computing device 102 and/or accessible on an account server 116 comprising a processor and a data store (e.g. storage devices) configured for storing account information including: account metadata for a user account and corresponding user information for characterizing each account including historical operations performed on each account and asset metadata for all users in each account associated with an institution.

For example, the account information may include user profile attributes and historical events on the account. Examples may include but not limited to: current financial income for the user, recurring withdrawals or deposits made on the account including associated accounts and schedule of recurrence, history of withdrawal or deposit transactions, etc.

Additionally, the content processing device 104 monitors online interactions within the data management application 114 for the user 113 when navigating an online account on the client computing device 102 (e.g. adding or deleting electronic data transfer contacts, interacting with online financial resources such as a mortgage calculator applications, searching online for additional financial educational topics to be displayed, searching on the application for additional financial asset product not currently held, etc.).

The data management application 114 may be a native application (e.g. downloadable from an application marketplace), a browser-based application accessed from the internet or a hybrid application and may be configured to obtain input to perform an action with respect to managing database records or accounts associated with a user 113 for a particular institution.

For example, the action being monitored by the content processing device may include but not limited to browsing, selecting, and interacting with one or more screens and screen icons, including account operation icons 109 and resource operation icons 111 presented on the GUI 112.

The content processing device 104 monitors and utilizes the online actions resulting from interactions with the user interface 112 of the data management application 114 and the account information (e.g. obtained from client computing device 102 and/or account server 116) to predict a user's interest in additional information and digital resources to be provided by the content processing device 104.

In one aspect, the resources presented (e.g. shown as resources info 110 in FIG. 1) may be web page links to external websites providing account services related to the user's interest and pre-determined as trusted by the institution associated with the account.

In another aspect, the resources presented (e.g. as resources info 110 in FIG. 1) may be a software application presented on the GUI 112 for use in predicting health of the account data in view of a corresponding goal for the data also at least based on the history of transactions on the account and the online actions in interacting with the GUI 112. For example, the resource provided by the content processing device 104 may be a software tool to track and alert when data in the account meets one or more pre-defined criteria.

In one example, the content processing device 104 may determine, based on the user's account information and online interactions with the GUI 112 (e.g. searches performed; accounts investigated further, etc.) that a user's predicted interest may be in online loan products provided by the institution. The content processing device 104 thus utilizes at least the user's account information including historical transactions performed on the account as well as online behavioural activity with the data management application 114 for the account to predict one or more digital online resources (e.g. resources info 110) to provide to the GUI 112 for subsequent display and interaction on the client computing device 102 alongside the account information (e.g. account info 108). As shown in the example of FIG. 1, the user's account information 108 characterizing the data within the account and/or account services available via one or more selectable account operation icon(s) 109 may be displayed concurrently on the screen with resources information 110 characterizing one or more online resources predicted to be of interest from the content processing device 104. The resources information 110 may be displayed in a summarized view in a first screen shown in FIG. 1 and then selectable via one or more resource operation icon(s) 111 to review further details of each particular resource (either in a new or at least partially in the current screen), including accessing web links to websites for the resource or downloading software application tools providing the digital resource determined to be of interest.

Thus, the client computing device 102, using the GUI 112 may receive an input to perform an action. In the present non-limiting example, the input may select one or more account operation icon(s) 109 to cause obtaining different views of the account data (e.g. view assets associated with the account for data health monitoring) or perform data transfer manipulations on the account data (e.g. send money online, perform online bill payment, deposit assets online, tap & pay, etc.).

The account server 116 may also act to process account manipulations such as data transfers on the account for the institution.

In the example of FIG. 1, the client computing device 102 is a mobile phone having a touchscreen device capable of receiving as input tactile interaction and/or keyboard input and/or external input to interact with the graphical user interface 112. Other examples of computing devices for the client computing device 102 may be envisaged such as but not limited to: a tablet computer, a tabletop computer, a portable gaming device, a portable media player, an electronic reading device, a smart watch or other smart device, or any other computing device.

In the example of FIG. 1, the account server 116 and the content processing device 104 are servers, however other types of computing devices having at least one processing device (e.g. a processor) and memory (e.g. a storage device) storing instructions which when executed by the associated computing device configure the computing device to perform operations, including those described herein in accordance with one or more embodiments.

Client computing device 102, the account server 116 and the content processing device 104 are coupled for communication to communication network 106 which may comprise a wide area network (WAN) such as the Internet. It is understood that the communications network 106 is simplified for illustrative purposes. The communications network 106 may comprise additional networks coupled to the WAN such as a wireless network and/or local area network (LAN) between the WAN and the client computing device 102 and/or account server 116 and/or content processing device 104.

Client computing device 102 may generate output for display on a screen of the GUI 112 in response to operation of the data management application 114. The output of the client computing device 102 may be displayed on other types of screen such as a projector, a monitor, or other display device. It will be understood that the user interface may also operate as an input/output device and may be configured using a variety of technologies (e.g. in relation to input capabilities: resistive touchscreen, a surface acoustic wave touchscreen, a capacitive touchscreen, a projective capacitance touchscreen, a pressure-sensitive screen, an acoustic pulse recognition touchscreen, or another presence-sensitive screen technology; and in relation to output capabilities: a liquid crystal display (LCD), light emitting diode (LED) display, organic light-emitting diode (OLED) display, dot matrix display, e-ink, or similar monochrome or color display).

Thus, the content processing device 104 processes information received from the client computing device 102 and utilizes prediction techniques such as machine learning algorithms to predict or forecast interest in additional digital content to be displayed in the form of digital online resources to provide via a customized user interface, shown as GUI 112 in FIG. 1.

In one non-limiting example, the customized user interface shown by the GUI 112 is thus dynamically configured via the content processing device 104, based on determining the user's interests (e.g. financial interests) when interacting with the data management application 114. In response, in one example, the GUI 112 may proactively present, in real-time, financial resources (e.g. external web links, links to native or browser applications, financial planning or budgeting tools, mortgage tools, credit health calculators, financial health calculators, etc.) that may be of interest to the user based on the content processing device 104 tracking online interactions with the data management application 114 and activities on a particular account (e.g. deposit trends, withdrawal trends, account transfers, types of assets associated with the account, etc.).

Preferably, the GUI 112 may proactively present digital resources via resources info 110 (either directly displayed on a screen of the GUI 112 or via links or otherwise selectable icons to display information on other screens, websites or applications) forecasted to be of interest alongside information relating to the user's current data health via account info 108 (e.g. financial spending patterns, saving patterns, trends for meeting a particular goal, etc.) in a single consolidated screen so that a user may quickly and efficiently be presented with possible digital resources to engage.

Thus, the GUI 112 provides a customized user interface for digital account data management application 114 and provides a one-stop resource of monitoring account data health information to interact more effectively to view and browse their current data health status for the account (e.g. financial health for a digital account) while being presented with one or more online resources (e.g. native or browser based) based on predicted interests determined by the content processing device 104 and customized to the user.

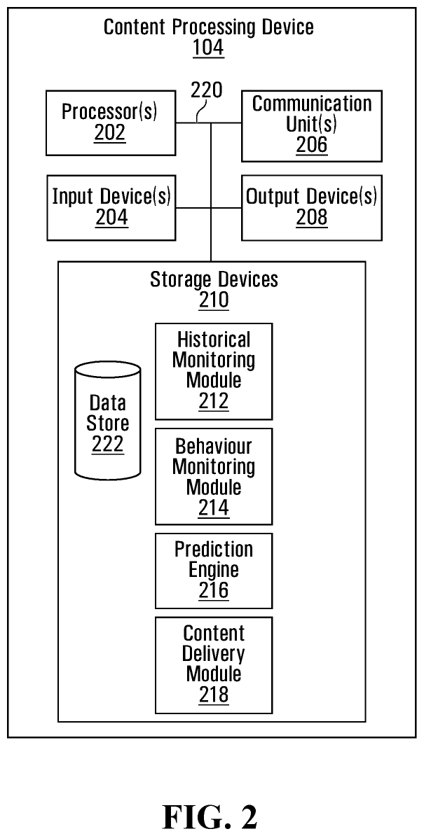

FIG. 2 is a diagram illustrating in block schematic form an example computing device (e.g. content processing device 104 shown in FIG. 1), in accordance with one or more aspects of the present disclosure, for example to provide a system to determine predictive resource information to display on a user interface of a data management application while accessing account services (e.g. data transfers) including data health information for an account.

Content processing device 104 comprises one or more processors 202, one or more input devices 204, one or more communication units 206 and one or more output devices 208. Content processing device 104 also includes one or more storage devices 210 storing one or more modules such as historical monitoring module 212, behaviour monitoring module 214, prediction engine 216 and content delivery module 218. Communication channels 220 may couple each of the components including processor(s) 202, input device(s) 204, communication unit(s) 206, output device(s) 208, storage device(s) 210, historical monitoring module 212, behaviour monitoring module 214, prediction engine 216 and content delivery module 218 for inter-component communications, whether communicatively, physically and/or operatively. In some examples, communication channels 220 may include a system bus, a network connection, an inter-process communication data structure, or any other method for communicating data.

One or more processors 202 may implement functionality and/or execute instructions within content processing device 104. For example, processors 202 may be configured to receive instructions and/or data from storage devices 210 to execute the functionality of the modules shown in FIG. 2, among others (e.g. operating system, applications, etc.). Content processing device 104 may store data/information to storage devices 210. Some of the functionality is described further herein below.

One or more communication units 206 may communicate with external devices (e.g. data transfer processing device 104) via one or more networks (e.g. communication network 106) by transmitting and/or receiving network signals on the one or more networks. The communication units 206 may include various antennae and/or network interface cards, etc. for wireless and/or wired communications.

Input devices 204 and output devices 208 may include any of one or more buttons, switches, pointing devices, cameras, a keyboard, a microphone, one or more sensors (e.g. biometric, etc.) a speaker, a bell, one or more lights, etc. One or more of same may be coupled via a universal serial bus (USB) or other communication channel (e.g. 220).

The one or more storage devices 210 may store instructions and/or data for processing during operation of content processing device 104. The one or more storage devices 210 may take different forms and/or configurations, for example, as short-term memory or long-term memory. Storage devices 210 may be configured for short-term storage of information as volatile memory, which does not retain stored contents when power is removed. Volatile memory examples include random access memory (RAM), dynamic random access memory (DRAM), static random access memory (SRAM), etc. Storage devices 210, in some examples, also include one or more computer-readable storage media, for example, to store larger amounts of information than volatile memory and/or to store such information for long term, retaining information when power is removed. Non-volatile memory examples include magnetic hard discs, optical discs, floppy discs, flash memories, or forms of electrically programmable memory (EPROM) or electrically erasable and programmable (EEPROM) memory.

Historical monitoring module 212 may be configured to obtain input from client computing device 102 and/or account server 116 providing historical account activity and characterizing data held on an account associated with a user of an institution. The historical account activity may include data defining operations performed on the account and metadata characterizing each product held on the account. For example, the data defining operations performed on the account may include but not limited to, events affecting the data over a period of time, transfers of data made into the account, transfers of data made out of the account, information regarding accounts which data is being transferred to/from, frequency of occurrence for each data transfer, event data associated with data transfer event including location, date and time of a transfer, information regarding recurring transferees or transferors of data, etc. Additionally, the historical monitoring module 212 tracks one or more products and product types held in the data records of the account. For example, in the context of financial accounts, the products held in an account might include different types of accounts (e.g. a trading account, mortgage, line of credit, etc.) and different categories of assets within the account (e.g. cash, bonds, stocks, loans, etc.).

Behaviour monitoring module 214 may receive input from the GUI 112 of the client computing device 102 which may be entered via touchscreen, keyboard, mouse, voice activated input or otherwise input when interacting online with the data management application 114 shown in FIG. 1. Such input may include interactions with the data management application 114 (e.g. either directly or indirectly) such as the account operation icons 109; resource operation icons 111; navigating one or more screens of the data management application 114; navigating to other applications or web resources and interacting with same relating to the account presented on the data management application 114, etc.

In response to input detected by the GUI 112, the behaviour monitoring module 214 may receive information for processing (either as single transfers of information or batch transfer). The information may be aggregated or grouped to generate one or more events related to online actions performed on the account when interacting with the user interface.

The events may include data representing a type of interaction with the GUI 112 (e.g. modifying an account, records related to the account, modifying data transfer information, performing queries on the account to view certain types of information, performing queries for additional types of accounts or additional types of records possible to be held in an account), a location of the computing device 102 when the input is received, a time when the input or part thereof is received at the location, and/or subsequent engagement with the GUI 112 after the event. As noted above, the events may be triggered via interaction with one or more account operation icon(s) 109 and/or resource operation icon(s) 111. The input events defining the online actions may be communicated to the content processing device 104 and specifically, the behaviour monitoring module 214 for further processing.

The prediction engine 216 may use the data associated with the one or more input events characterizing online actions resulting from interactions with the GUI 112 for the data management application 114 tracked by the behaviour monitoring module 214 and the historical activity on the account provided by the historical monitoring module 212 to determine a response. The prediction engine 216 is configured to predict based on the account history and the online actions (respectively provided by the modules 212 and 214), a user's interest or intent for subsequent information on the GUI 112 of the data management application 114.

The prediction engine 216 may be configured to utilize the account history information monitored by the historical monitoring module 212 to determine historical data trends or patterns for the account and online interaction data to determine patterns of use for the data management application such as to determine based on the past data, a forecasted current and/or future interest for the user in viewing and accessing subsequent online resources. The user's predicted interest is communicated to the content delivery module 218 for determining suitable online content to display on the GUI 112 based on the attributes and capabilities of the data management application. For example, this may result in one or more resources info 110 including selectable and interactive resource operation icons 111 to be displayed on the GUI 112.

In one example, the prediction engine 216 may determine based on the account activity that a recurring type of data record (e.g. an online deposit transfer) which was being added to the online account on a scheduled basis is no longer occurring. Additionally, the prediction engine 216 may receive input indicating that the GUI 112 has been used to query (either via the digital management application 114 directly or via external websites) for information regarding additional types of accounts and products. Accordingly, in this example, the prediction engine 216 may determine that based on the historical patterns, the user may have lost a source of income and is interested in online tools related to loan products. The prediction engine 216 may then trigger the content delivery module 218 to retrieve, from a data store 222, content relevant to the user's forecasted interest. For example, the data store 222 may include a mapping table between pre-defined categories of interest for particular account types and one or more corresponding resources (e.g. software tools, links to websites, etc.) which may be of interest to send to the client computing device 102 for subsequent presentation on the GUI 112.

In one aspect, the historical monitoring module 212 may track historical transaction activity for all accounts associated with an institution over a past time period, characteristics of data held in the account including the types of data, the source and destination for data events, and account profile characteristics for each account such as demographics profile of the user. On the other hand, the behaviour monitoring module 214 tracks online user interface activity performed on each user interface (e.g. GUI 112) for all user accounts (e.g. for all customers of the institution).

The prediction engine 216 may then first determine whether a particular account's history and account profile characteristics is similar to one or more other accounts held with the institution. If other similar accounts are located, then the prediction engine 216 may further determine the interests of the user additionally based on other similar users. That is, the prediction engine 216 collaborates with the content delivery module 218 to predict one or more online resources (e.g. native or browser based applications, screens and links to internal or external resources) that may be of interest to the user for display on a particular user interface (e.g. GUI 112) by utilizing the user's account history, online actions performed on the account characterizing behaviour of the user in interacting with the GUI 112, and tracked online behaviour actions from all the other similar users. Thus, based on determining a user's interest in resources at least from the determined interests of other similar users, the content delivery module 218 cooperates with the prediction engine 216 to forecast which financial resources (e.g. educational information to display/software resource tools, etc.) a user is interested in viewing at the current time on the user interface (e.g. GUI 112) of the data management application.

In one aspect, the behaviour monitoring module 214 is configured to constantly track application activity for the data management application 114 such that as a user of the GUI 112 continues to interact with the data management application 114 to perform operations and/or other types of interactions with one or more screen elements on the GUI 112, such as to perform application queries, browse to view specific application products on the account, reviews specific account functions available on the GUI 112, rejects other services or functions available on the GUI 112, etc. then the prediction engine 216 constantly updates the forecast of the user's interest and thereby triggers the content delivery module 218 to update one or more financial resources displayed in screen elements of the user interface (e.g. GUI 112) of the data management application 114.

In one aspect, the behaviour monitoring module 214 may also track a geographic location of the client computing device 102 when interacting with the data management application 114 for further determining the user's interests and corresponding resources to display on the GUI 112 (e.g. via prediction engine 216 and content delivery module 218). For example, if a user accesses the user interface of the data management application 114 while located at a car dealership, then the content delivery module 218 may further tailor the resources displayed to specific planning tools and/or data health monitoring tools, e.g. borrowing, budgeting, etc. based on the user's historical data.

Thus, the content delivery module 218 provides online/application resources proactively and in real-time for the user interface 112 to display (e.g. resources may be provided in the form of screen elements, screens, links to content, links to download software tools, etc.) based on information related to the user's determined intent at a particular point in time.

In one aspect, the prediction engine 216 analyzes input received regarding past account history for an account as well as user interface behaviour information for the GUI 112 (e.g. user interactions with a particular data management application 114). The prediction engine 216 may further be configured to additionally analyze the account history as provided by the historical monitoring module 212 to determine data transfer patterns or trends in the account characterizing behaviour of data transfer operations performed on the account including product categories involved in the data transfer operations, associated frequency and timeline. Based on analyzing the account history for trends, the prediction engine 216 may then further update the predicted user's interest to account for any recurring patterns or trends in the account history and trigger the content delivery module 218 to update the resources provided based upon the detected data transfer patterns in the history.

For example, the prediction engine 216 in the current example may determine that the periodic data transfers into the account have stopped and thus trigger the content delivery module 218 to display one or more resources providing information regarding data budgeting tools.

In another example, the prediction engine 216 may detect that a financial account consistently carries a certain amount of data (e.g. a balance of assets) and thus the user's predicted interest may relate to investments additionally based on tracking online behaviour via the behaviour monitoring module 214, and thus the content delivery module 218 may be configured to proactively provide financial resources and software tools relating to investing options and/or retirement plans for display on the GUI 112.

Referring to FIG. 2, the content delivery module 218 is configured to determine certain information to present in the user interface of the computing client device 102 (e.g. GUI 112) which may be obtained from data transfer processing device 104 (e.g. its data store 222) for example, looking up data or links to data stored and mapped to specific categories of interest types, on behalf of the user.

It is understood that operations may not fall exactly within the modules 212, 214, 216, 218 and 222 of FIG. 2 such that one module may assist with the functionality of another.

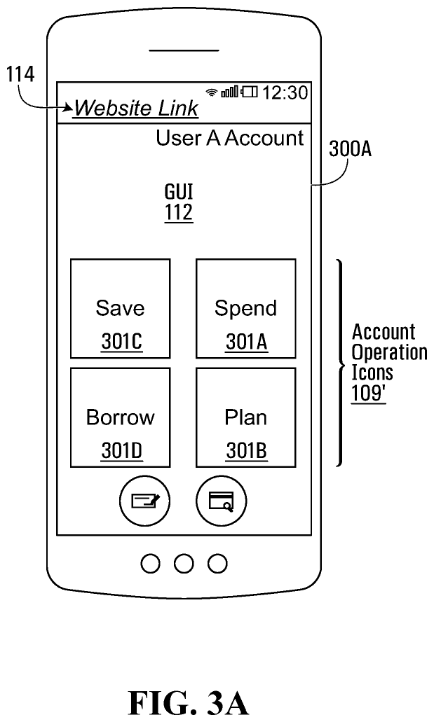

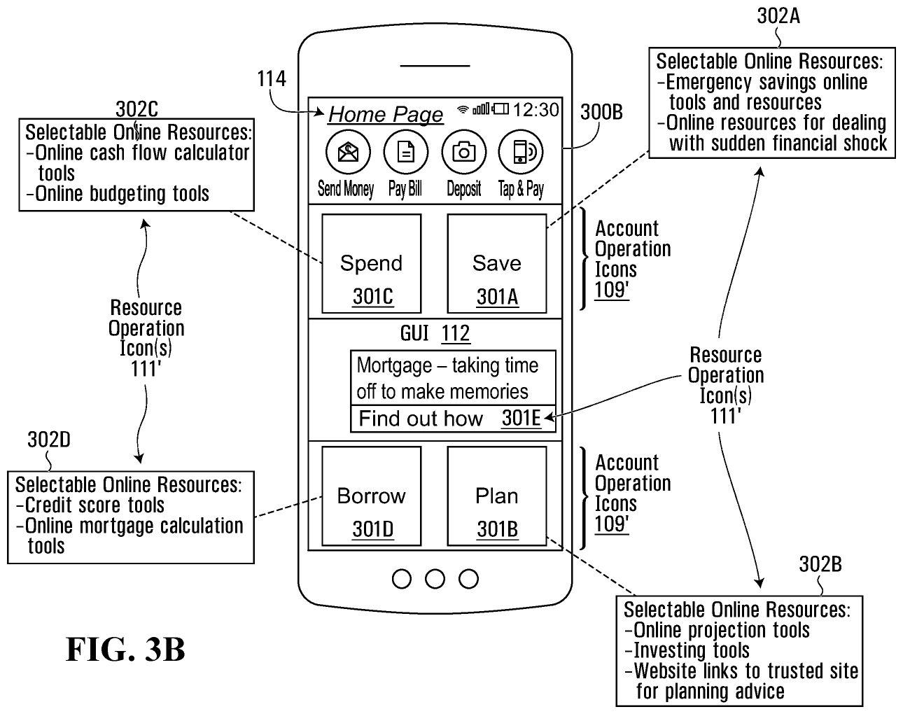

FIGS. 3A and 3B are diagrams illustrating example screens displayed on a graphic user interfaces (GUI), in accordance with one or more aspects of the present disclosure.

Specifically, FIGS. 3A and 3B illustrate the GUI 112 for presenting a consolidated set of data management functions and information based on current requests for information and predicted future interests provided in a screen of an example user interface of a data management application 114, e.g. a digital banking application illustrated in FIGS. 3A and 3B.

Referring to FIG. 3A, a first example screen 300A, has a first region depicting a first set of selectable icons for performing account operations and/or reviewing account information for a particular user's account. In the example depicted, the account operation icons 109′ include a set of selectable icons, displayed as the following screen elements 301A-301D respectively corresponding to labelled items: spend, plan, save and borrow for receiving input and invoking an action or displaying information to the user related to the selected icons. The account operation icons 109′ thereby provide a set of high-level menu options for subsequent navigation.

Referring to FIG. 3B, shown is an example second screen 300B providing various display configurations when one or more of the menu options such as account operations icons 109′ are engaged. The account operation icons 109′ are provided as a first set of selectable icons (e.g. screen elements 301A-301D) which may thus be engaged for further detailed view and manipulation of the account information either partially or as a whole in another screen on the GUI 112. In one example, once the first set of selectable icons (e.g. screen elements 301A-301D) are selected, or otherwise hovered upon, this can either initiate a new screen and/or display portions of possible selectable resource controls shown as resource display portions 302A-302D.

The resource display portions 302A-302D or 301E each provide a second list of selectable resource operation icons 111′ for subsequent selection and access to additional resource operations. For example, hovering over an account operation icon 109′ shown as “save” (screen element 301A) will provide behavioural input to the content processing device 104 indicative of the online action performed which will in response to this action and previously collected account history information (e.g. via the historical monitoring module 212 in FIG. 2) dynamically and in real-time generate resource information customized to the user for viewing on the GUI, for example shown as resource operation icons 111′.

Referring to FIG. 3B, a summary view of a first set of selectable icons shown as screen elements 301A-301D corresponding to account information and/or account services may be shown simultaneously on a screen of the data management application along with a summary view of a second set of selectable icons (e.g. shown as resource display portion 301E) corresponding to predicted resources which may be of interest to the user.

Thus, as shown in FIG. 3B, the resources may be displayed on the screen of the data management application 114 as an interactive set of selectable display screen tiles (e.g. resource display portions 301E, 302A-302D) which may additionally be organized by content category of the resources.

Preferably, in the digital banking application example context illustrated in FIGS. 3A and 3B, this allows viewing and/or manipulating current financial health situation of the user account (e.g. sending money, paying bills, etc.) as well as simultaneously viewing and accessing customized financial resources generated based on forecasted interest which have been proactively selected and pushed to the GUI 112 via the content processing device 104. The financial resources shown in the resource display portions 302A-302D may be displayed in further detail in one or more separate screens once selected alongside account information. The predictive financial resources, e.g. as shown in display portions 302A-302D, can include forecasted financial software tools, either browser-based or native format (e.g. pension calculator, budgeting tools, and emergency savings tools) generated by the content processing device 104 based on the predicted user's interest for additional information considered to be of interest from a current time up to a future time.

In the illustrated example of FIGS. 3A-3B, the user interface (e.g. GUI 112) may provide a consolidated customized education and advice hub, integrating data management resource tools available via the organization with trusted third party tools and content displayed as aggregated resource icons.

That is, in at least one aspect, the content processing device 104 may store information (e.g. via the data store 222 in FIG. 2) regarding third party software and/or websites considered trusted by the institution in order to generate resource content for display on the GUI 112 from only the trusted sources.

Additionally, referring to FIGS. 1, 2, 3A, and 3B, in at least some aspects, once the user 113 of the user interface (e.g. GUI 112) continues to interact with the menu options provided on the screen (e.g. scrolling to or selecting particular functions or resources over others, e.g. resource operation icons 111′) then the prediction engine 216 is configured to dynamically update the user's predicted interest and thereby the set of digital predictive resources provided to the GUI 112 for display from the present time until a future time.

Thus, the GUI 112 may present a consolidated user interface via the data management application 114 providing users (e.g. customers of the institution) with a one-stop resource for dealing with management and accessibility of the data in the account including their current selected interests and potential forecasted future interests in resources.

As shown in FIG. 3B, the resources and data management information may be displayed as a number of screen tiles (e.g. 301A-301E) oriented on the user interface page of the data management application 114 such that when a user hovers over a screen tile, e.g. 301A-301D the functions that are available by selecting the icon are then displayed for subsequent selection and interaction.

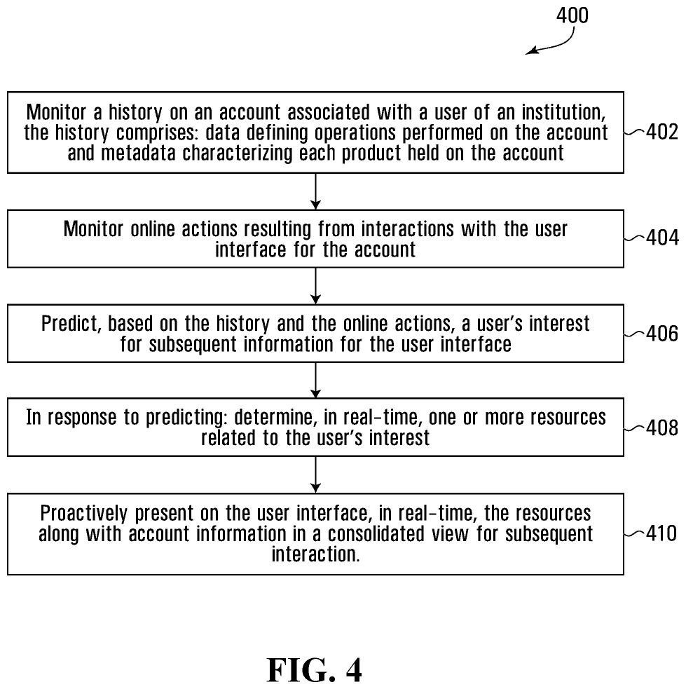

FIG. 4 is a flowchart of operations 400 which may be performed by a computing device, such as the content processing device 104 illustrated in FIG. 1. The content processing device 104 may comprise a processor configured to communicate with a display (e.g. GUI 112 on client device 102) to provide a graphical user interface (GUI) such as GUI 112 wherein the content processing device 104 receives input, across the communications network 106 shown in FIG. 1 to determine predictive information to display on the GUI 112 in response to the input. Notably, the content processing device 104 stores instructions (stored in a non-transient storage device), which when executed by the processor, configure the content processing device 104 to perform operations such as operations 400.

At 402, operations receive input from a computing device (e.g. client device 102 and/or account server 116) indicating account activity history associated with a user of an institution, the account history including data defining operations performed on the account over a past period of time and metadata characterizing each product held on the account. For example, the account history may include data transfers performed to transfer data to/from an account on the client computing device 102, time, location of transfer and information regarding the parties involved. The account history may also include additional insights regarding the account activity including a frequency of occurrence of data manipulation, new data record entries created, etc. The account history may also include additional information characterizing the user assigned to the account, including the account history may also include a listing and definition of one or more product types (e.g. assets) held in the account over a past time period.

At 404, operations monitor and receive additional information from the client device 102 indicative of online actions resulting from interactions with the user interface of the client computing device 102 (e.g. GUI 112 shown in FIG. 1) for the account. As described earlier, the online actions may include one or more queries or searches for additional information made on the GUI or on external websites while navigating the GUI 112 relating to the account. Other examples of the online actions, may include for example, interacting with one or more account operation icons 109 on the data management application 114 in order to manipulate the data in the account. Another example includes navigating screens presented via the GUI 112 to select and drill down to particular types of account operations.

At 406, operations are configured to predict based on the account history and the online actions, a user's interest for subsequent information on the user interface, e.g. GUI 112. One or more suitable machine learning models may be used to perform the prediction based on the input described herein, including any existing machine learning models known to those skilled in the relevant arts or any suitable yet to be developed machine learning models.

At 408, operations are configured to, in response to predicting the user's interest, determine in real time one or more resources related to the user's interest. For example, this may include trusted websites or trusted native applications which may be accessed via the GUI 112 based on the corresponding predicted interest.

At 410, operations are further configured to proactively present on the user interface, e.g. GUI 112, in real-time, the digital resources determined to be related to the user's predicted interest along with account information (e.g. information characterizing one or more aspects of the account, account operations available or the data held within the account) in a consolidated view for subsequent interaction.

In one aspect, proactively presenting the resources at 410 further includes displaying the resources as an alert on a screen of the client computing device 102 in response to navigating and interacting with the user interface of the data management application 114. Displaying such an alert may include for example presenting the alert containing the resource within the user interface (e.g. GUI 112 of the data management application 114 described in FIG. 1) or within any other screen of the client computing device 102 where application alerts may be displayed (e.g. on a home screen of the client computing device 102 when in locked mode).

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit.

Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium. By way of example, and not limitation, such computer-readable storage media can comprise RAM, ROM, EEPROM, optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using wired or wireless technologies, such are included in the definition of medium. It should be understood, however, that computer-readable storage media and data storage media do not include connections, carrier waves, signals, or other transient media, but are instead directed to non-transient, tangible storage media.

Instructions may be executed by one or more processors, such as one or more general purpose microprocessors, application specific integrated circuits (ASICs), field programmable logic arrays (FPGAs), digital signal processors (DSPs), or other similar integrated or discrete logic circuitry. The term “processor,” as used herein may refer to any of the foregoing examples or any other suitable structure to implement the described techniques. In addition, in some aspects, the functionality described may be provided within dedicated software modules and/or hardware. Also, the techniques could be fully implemented in one or more circuits or logic elements. The techniques of this disclosure may be implemented in a wide variety of devices or apparatuses, an integrated circuit (IC) or a set of ICs (e.g., a chip set).

One or more currently preferred embodiments have been described by way of example. It will be apparent to persons skilled in the art that a number of variations and modifications can be made without departing from the scope of the invention as defined in the claims.

What is claimed is:

1. A content processing device communicating with a computing device across a communication network, the content processing device having a processor coupled to a memory, the memory storing instructions, which when executed by the processor configure the content processing device to:
monitor, via the computing device, a history on an account associated with a user of an institution, the history comprises: data defining operations performed on the account over a period of time and metadata characterizing each product held on the account over the period of time;
monitor online actions resulting from interactions with a user interface of a data management application on the computing device for the account;
predict, based on the history and the online actions, a user's interest for subsequent information for the user interface on the computing device;
in response to said prediction:
determine, in real-time, one or more resources related to the user's interest; and,
proactively present on the user interface, in real-time, the resources along with account information for performing one or more account operations in a consolidated view for subsequent interaction.

2. The device of claim 1 wherein the online actions further comprise one or more queries for additional information made on the user interface relating to the account.

3. The device of claim 2, wherein the instructions further configure the content processing device to:
receive a first interaction selecting on the user interface one of the resources for further detailed display; and,
update the user's interest further based upon the first interaction to determine and present on the user interface the resources based on the updated user's interest.

4. The device of claim 2, wherein the instructions further configure the content processing device to present in a consolidated view on a screen of the user interface a summarized view of icons comprising:
the account information defining the history associated with a first selectable icon for further detailed view and manipulation of the account information in a second screen on the user interface; and,
the resources associated with a second selectable icon for further detailed view and manipulation in a third screen on the user interface.

5. The device of claim 4, wherein the resources presented are web page links to external websites providing account services related to the user's interest and determined as trusted by the institution.

6. The device of claim 4, wherein the resources are software application tools presented on the user interface for predicting health of the account in view of a corresponding goal for the data and at least based on the history and the online actions.

7. The device of claim 1 wherein the resources are presented as an interactive set of selectable display tiles on a screen of the user interface organized by content category of the resources.

8. The device of claim 1, wherein the instructions further configure the content processing device to further analyze the history to determine data transfer patterns in the account characterizing behaviour of data transfer operations on the account including product categories involved in the data transfer operations, associated frequency and timeline; and further wherein the resources are additionally updated based upon the data transfer patterns in the history.

9. The device of claim 1, wherein proactively presenting the resources further comprises displaying the resources as an alert on a screen of the user interface in response to navigating and interacting with the user interface.

10. The device of claim 1, wherein the instructions further configure the content processing device to:
receive profile attributes for the user and other users of the institution;
determine a set of the other users of the institution having similar demographic data based on the profile attributes;
track an online behaviour pattern of the set of the other users of the institution in interacting with respective user interfaces for customization of information provided thereon; and
wherein the user's interest in subsequent information is further updated based on the online behaviour pattern of the set of the other users and used for determining and presenting the resources based on the update.

11. The device of claim 1, wherein the instructions further configure the content processing device for: tracking a current geographic location of the computer device when interacting with the data management application, and further determining the user's interest based on the current geographic location to further customize the resources displayed only to those relevant to the current geographic location.

12. A computer implemented method for providing predictive information on a user interface of a data management application of a computer device, the method comprising:
monitoring a history on an account associated with a user of an institution, the history comprises: data defining operations performed on the account over a period of time and metadata characterizing each product held on the account over the period of time;
monitoring online actions resulting from interactions with the user interface for the account;
predicting, based on the history and the online actions, a user's interest for subsequent information for the user interface;
in response to said predicting:
determining, in real-time, one or more resources related to the user's interest; and,
proactively presenting on the user interface, in real-time, the resources along with account information for performing one or more account operations in a consolidated view for subsequent interaction.

13. The method of claim 12 wherein the online actions further comprise one or more queries for additional information made on the user interface relating to the account.

14. The method of claim 13 further comprising:
receiving a first interaction selecting on the user interface one of the resources for further detailed display; and,
updating the user's interest further based upon the first interaction to determine and present on the user interface the resources based on the updated user's interest.

15. The method of claim 13 further comprising:
presenting in a consolidated view on a screen of the user interface a summarized view of icons comprising:
the account information defining the history associated with a first selectable icon for further detailed view and manipulation of the account information in a second screen on the user interface; and,
the resources associated with a second selectable icon for further detailed view and manipulation in a third screen on the user interface.

16. The method of claim 15, wherein the resources presented are web page links to external websites providing account services related to the user's interest and determined as trusted by the institution.

17. The method of claim 15, wherein the resources are software application tools presented on the user interface for predicting health of the account in view of a corresponding goal for the data and at least based on the history and the online actions.

18. The method of claim 12 wherein the resources are presented as an interactive set of selectable display tiles on a screen of the user interface organized by content category of the resources.

19. The method of claim 12, wherein the history is further analyzed to determine data transfer patterns in the account characterizing behaviour of data transfer operations on the account including product categories involved in the data transfer operations, associated frequency and timeline; and further wherein the resources are additionally updated based upon the data transfer patterns in the history.

20. The method of claim 12, wherein proactively presenting the resources further comprises displaying the resources as an alert on a screen of the user interface in response to navigating and interacting with the user interface.

21. The method of claim 12, further comprising:
receiving profile attributes for the user and other users of the institution;
determining a set of the other users of the institution having similar demographic data based on the profile attributes;
tracking an online behaviour pattern of the set of the other users of the institution in interacting with respective user interfaces for customization of information provided thereon; and
wherein the user's interest in subsequent information is further updated based on the online behaviour pattern of the set of the other users and used for determining and presenting the resources based on the update.

22. The method of claim 12, further comprising: tracking a current geographic location of the computer device when interacting with the data management application, and further determining the user's interest based on the current geographic location to further customize the resources displayed only to those relevant to the current geographic location.
